(19) United States
(12) Patent Application Publication
(10) Pub. No.: US 2005/0193074 A1
(43) Pub. Date: Sep. 1, 2005

(54) Method of communications via e-mail with media file attachment

(76) Inventor: Andrew S. Garland, Round Rock, TX (US)

Correspondence Address: LITMAN LAW OFFICES, LTD, PO BOX 15035, CRYSTAL CITY STATION, ARLINGTON, VA, 22215, US

(21) Appl. No.: 11/013,441

(22) Filed: Dec. 17, 2004

Related U.S. Application Data
(60) Provisional application No. 60/548,114, filed on Feb. 27, 2004.

(51) Int. Cl. G06F 15/16

(52) U.S. Cl. 709/206

(57) ABSTRACT

The method of communications via e-mail with media file attachment incorporates advanced communications methods into an e-mail system while enhancing the delayed conversation effect inherent in communications via e-mail reply. User messages are recorded in media files and attached to e-mail letters. The media files include identification information associating the user message with an e-mail conversation, and are stored according to a predetermined scheme. Incoming file attachments are examined to determine first whether they are designated for use in this invention, and if so, second whether they are media files that are part of an existing conversation. If an incoming media file is designated as part of an existing conversation, links corresponding to past media files associated with the conversation are displayed. Designated media files that are not associated with an existing conversation are stored for reference in future conversations.

### CROSS-REFERENCE TO RELATED APPLICATION

This application claims the benefit of U.S. Provisional Patent Application Ser. No. 60/548,114, filed Feb. 27, 2004.

### BACKGROUND OF THE INVENTION

1. Field of the Invention

The present invention relates to the use and handling of electronic mail (e-mail) attachments, and particularly to a method of verbal and/or visual communication through digitally recorded media files utilizing the delayed conversation effect of an e-mail system.

2. Description of the Related Art

E-mail, as referred to in this application, is a network based text communication device. Through the Internet, e-mail has grown to become a prevalent form of information exchange. Speed, low cost, ease of use and numerous useful and now familiar features such as “forward” and “reply” have propelled e-mail from minor use in a limited segment of population into a common means of communication used world wide. However, in the fast paced Internet world, progressions to improved forms of communication are likely on the horizon. The natural evolution of communication would seem to lead to audio Internet communication, followed by audiovisual Internet communication. Generally speaking, these advances are possible to achieve today, but the average Internet user lacks the hardware to adequately support-programs utilizing such methods.

Designers and programmers of next generation Internet communication devices are anxiously awaiting societal technological progress for widespread support of more advanced methods of communication, such as high quality streaming video for real time video conferencing. In the present course of events, there is a high possibility that the communications technology community will inadvertently disregard the advantageous delayed conversation effect of e-mail while planning for the next communications break-through.

The ease of creating and maintaining the conversation history is one of the often overlooked benefits of e-mail. It provides the ability to review an entire discussion that may have taken place spread out over days, or even weeks. This feature can be invaluable in refreshing one's memory in order to enable continued, intelligent and informed responses to numerous correspondents on a wide range of topics, seemingly simultaneously. In addition, the benefit comes at little cost. Stacking replies, building long conversation histories and mailing them back and forth has no noticeable effect on e-mail celerity.

There are currently no devices or methods aiming to enhance, or even preserve, the delayed conversation effect in addition to improving the communication form of e-mail. Ideally, such a method would support the use of advanced forms of communication combined with an archival conversation history of past correspondences. Such a feat cannot be achieved using conventional e-mail techniques, such as forwarding media file attachments, alone. While the conversation effect would be maintained, albeit somewhat awkwardly, the size of the e-mail package as a whole would quickly grow to enormous and unmanageable proportions that would require too much time to download using average network communications means.

U.S. Pat. No. 6,563,912, issued May 13, 2003 to Dorfman et al., discloses a method for integrating voice-mail with e-mail in a system comprising a voice-mail server, an e-mail server, and an e-mail client. The method includes the steps of recording an audio message and associating it with an e-mail letter, and requires the deletion of prior letters sent in order to function properly.

U.S. Patent Publication No. 2001/0044829, published on Nov. 22, 2001, describes a remote e-mail management and communication system and method of routing e-mail attachments. The method includes the steps of identifying the file of the attachment, launching an appropriate application, if possible, and maintaining a history list corresponding to the application program. In one embodiment, the attached file may be an audio file, video file, multimedia file or graphics file.

U.S. Pat. No. 6,256,666, issued Jul. 3, 2001 to S. K. Singhal, discloses a method and system for remotely managing e-mail attachments. The invention uses an “Attachment Control Message” attached to the e-mail message to send instructions called “Attachment Commands” remotely from a mobile client to an e-mail server. A “Mobile Access Gateway” program at the e-mail server processes these attachments, and a “Mobile Message Processor” intercepts and interprets the “Attachment Control Messages” and “Attachment Commands.” Various actions, such as deleting attachments or launching a viewer application, may be initiated in response to the “Attachment Commands.”

U.S. Patent Publication No. 2001/0034225, published Oct. 25, 2001, describes a one-touch method and system for providing e-mail to a wireless communication device.

Other similar patents and patent application publications include U.S. Patent Publication No. 2002/0194279, published Dec. 19, 2002 (method of creating voice attachments and sending as attachments to e-mail using a wireless communication device); U.S. Patent Publication No. 2002/0194281, published Dec. 19, 2002 (method of audio reply to text e-mail on a portable electronic device); U.S. Patent Publication No. 2003/0041111, published on Feb. 27, 2003, (system for extracting an audio file embedded in an image file, and attaching the audio file to an image file in an e-mail message); and U.S. Pat. No. 6,212,551, issued on Apr. 3, 2001 to S. Asghar et al. (digitized audio data attachment to a text message).

None of the above inventions and patents, taken either singly or in combination, is seen to describe the instant invention as claimed. Thus, a method of communications via e-mail with media file attachment as described herein solving the aforementioned problems is desired.

### SUMMARY OF THE INVENTION

The present invention is a method of communications via e-mail with media file attachment incorporates advanced communications means into an e-mail system while enhancing the delayed conversation effect inherent in communications via e-mail reply. Messages are created using media files and attached to e-mail letters. The files include identification information encoded therein and are stored according to a predetermined scheme. Incoming file attachments are examined to determine first, whether they are designated for use in this invention, and if so, second, whether they are media files that are part of an existing conversation. If an incoming media file is designated as part of an existing conversation, links corresponding to past media files associated with the conversation are displayed. Designated media files that are not associated with an existing conversation are stored for reference in future conversations. An appreciable conversation history of media files is therefore maintained using minimal network resources.

These and other features of the present invention will become readily apparent upon consideration of the following specification and drawings.

### BRIEF DESCRIPTION OF THE DRAWINGS

FIG. 1 is a diagram representing communication flow according to the method of the present invention.

FIG. 2 is a block diagram representing a first user sending a new message to a second user according to the method of the present invention.

FIG. 3 is a block diagram representing the second user sending a reply message to the first user according to the method of the present invention.

FIG. 4 is a block diagram representing the first user sending a reply message to the second user according to the method of the present invention.

FIG. 5 is a block diagram representing a third user sending a new message to the second user according to the method of the present invention.

FIG. 6 is a screen shot of a desktop mail client implementing the present invention, showing a message initiation button added to a display toolbar.

FIG. 7 is a screen shot of a desktop mail client implementing the present invention, showing a “stop recording” button added to a display toolbar.

FIG. 8 is a screen shot of a desktop mail client implementing the present invention, showing a audio message reply buttons added to a display toolbar.

FIG. 9 is a screen shot of a desktop web client displaying a popup window created by a web-mail server implementing the present invention, the popup window including an icon to initiate an audio e-mail message.

FIG. 10 is a screen shot of a desktop web client displaying a popup window created by a web-mail server implementing the present invention, the popup window including an icon to stop recording the audio e-mail message.

FIG. 11 is a screen shot of a desktop web client displaying a popup window created by a web-mail server implementing the present invention, the popup window including an icon to send the audio e-mail message.

FIG. 12 is a screen shot of a desktop web client displaying a popup window created by a web-mail server implementing the present invention, the popup window including icons to initiate a new audio e-mail message, and icons linking to previous messages related to a received audio e-mail message.

FIG. 13 is a screen shot of a desktop web client displaying a web-mail display generated by a web-mail server implementing the present invention, the display including an integrated icon to initiate an audio e-mail message.

Similar reference characters denote corresponding features consistently throughout the attached drawings.

### DETAILED DESCRIPTION OF THE PREFERRED EMBODIMENTS

The present invention is a method of improved communications via e-mail with media file attachments. It should be understood that certain terms in this description are part of the common vernacular used within the context of a typical network environment and are familiar to those skilled in the art. In particular, the term “e-mail” refers to the exchange of encoded computer stored information, typically ASCII text, by means of telecommunication through a network, such as the Internet. The terms “send” and “receive” refer to, respectively, the dispatch of an e-mail letter or message to a particular user or group of users within the network and the acceptance and receipt of such a letter or message by the user or group of users. The term “attach” refers to the sending of additional files, such as, but not limited to, audio, video, or graphics files, via an e-mail letter or message. An “e-mail reader” is a program used specifically for sending and receiving e-mail and downloading attachments sent with the e-mail. A web-mail server is a network server system, generally on the Internet, that hosts an e-mail service whereby users access services to compose, send, receive, and read e-mails using an Internet or web client or web browser program such as Microsoft Internet Explorer. The term “computer” is to be interpreted in the generic sense as an electronic processing device capable of network communication, including but not limited to desktop computers, laptops, notebooks, tablet PC's, PDA's, and cell phones. The term “cache” refers to a temporary storage place. “Media” refers to electronic communication means including, but not limited to, digital audio, visual, or audiovisual recording. Additional terms will be referred to periodically in a context not currently in use in the art.

It should also be appreciated that the following description omits reference to any particular operating system or programming language. The method of the present invention may be implemented in any conventional language and designed to operate in any operating system. Therefore reference to “the program” will imply any program, regardless of language, computer or operating system that is employing the method of the present invention.

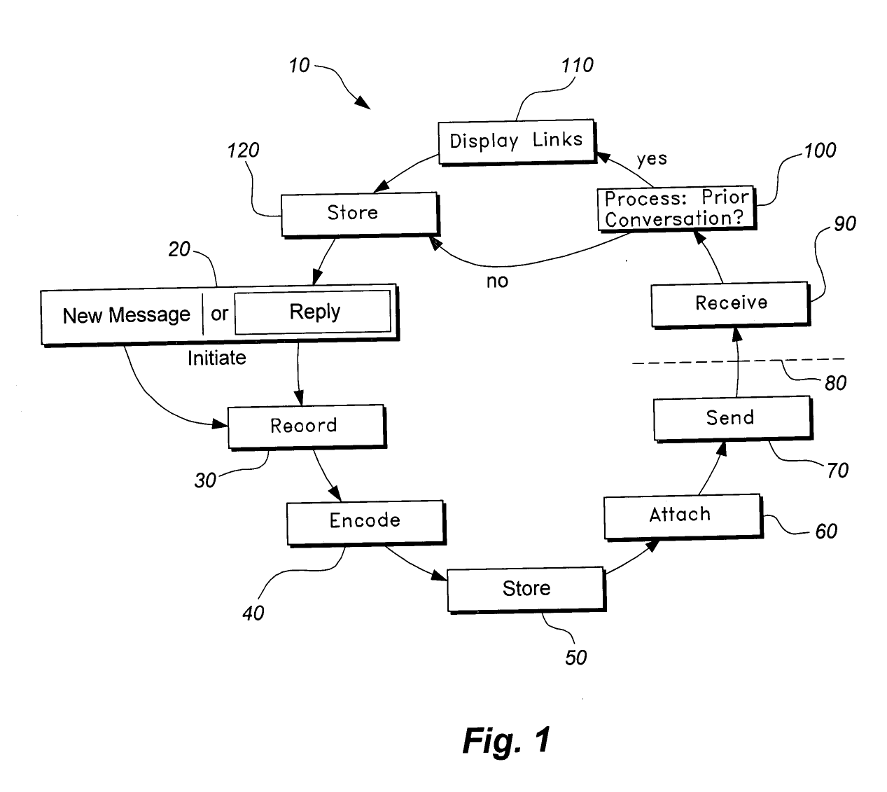

FIG. 1 shows a diagram 10 of a method of delayed conversation via media e-mail attachments. The diagram illustrates the steps of an exchange process 10 between a sender and a receiver in the initiation and continuation of a delayed conversation. Briefly, a sender initiates a message, resulting in the creation of an outgoing e-mail letter, as indicated at 20. A media file is created and a user message is recorded 30 simultaneously. The media file is marked 40 with additional encoding for future recognition and identification. A copy of the encoded media file is afterward stored 50 and attached 60 to an outgoing e-mail letter. The e-mail letter is sent 70 and subsequently received 90.

The receiver receives the e-mail letter and processes 100 all incoming attachments, checking for media files having encoded identification information. If the attachment does not contain recognizable identification information, it is disregarded. If the attachment contain recognizable identification information and is a reply message, links to past messages of the same conversation are displayed 110. If the attachment is recognized but is not a reply, the message is stored 120 on the receiver's side. At this point the process will have undergone a complete cycle, leaving the possibility of the sender and receiver switching roles. The original receiver may now become a sender by initiating a reply 20 to the original sender, thereby restarting the cycle. The same steps will be followed until the users decide to discontinue or abandon the conversation.

With a brief overview of the method of delayed conversation via media e-mail attachments, it can be understood that the method of delayed conversation via media e-mail attachments may be embodied in a desktop e-mail client program executing on a user's computer, such as Microsoft Outlook®, or may be embodied in a e-mail or web-mail server operating on a server computer and accessed by a web client program, such as Microsoft Internet Explorer®, running on the user's computer.

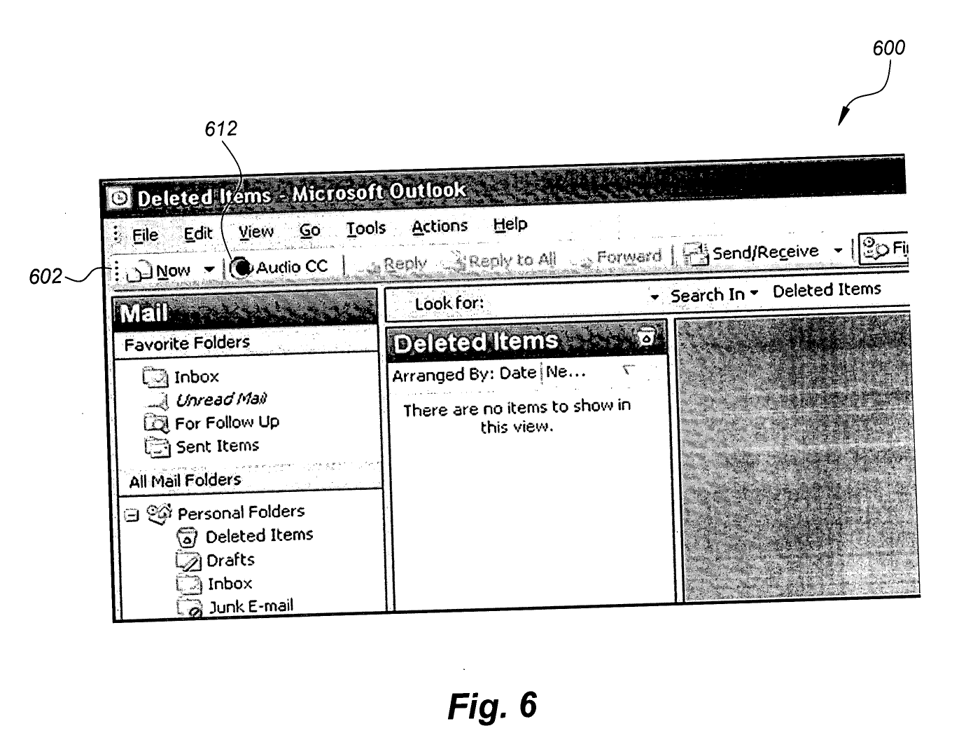

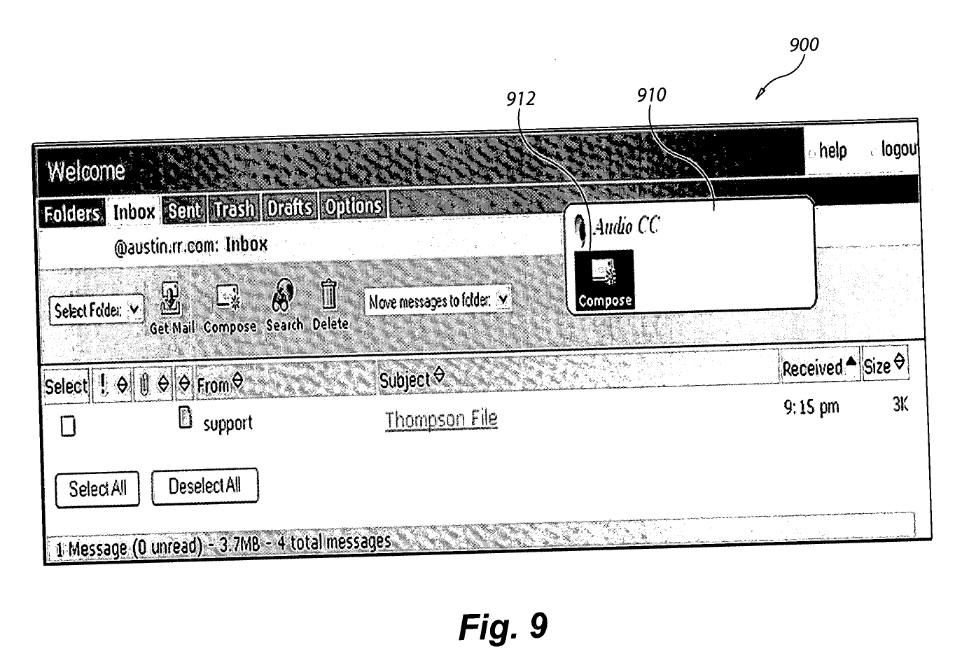

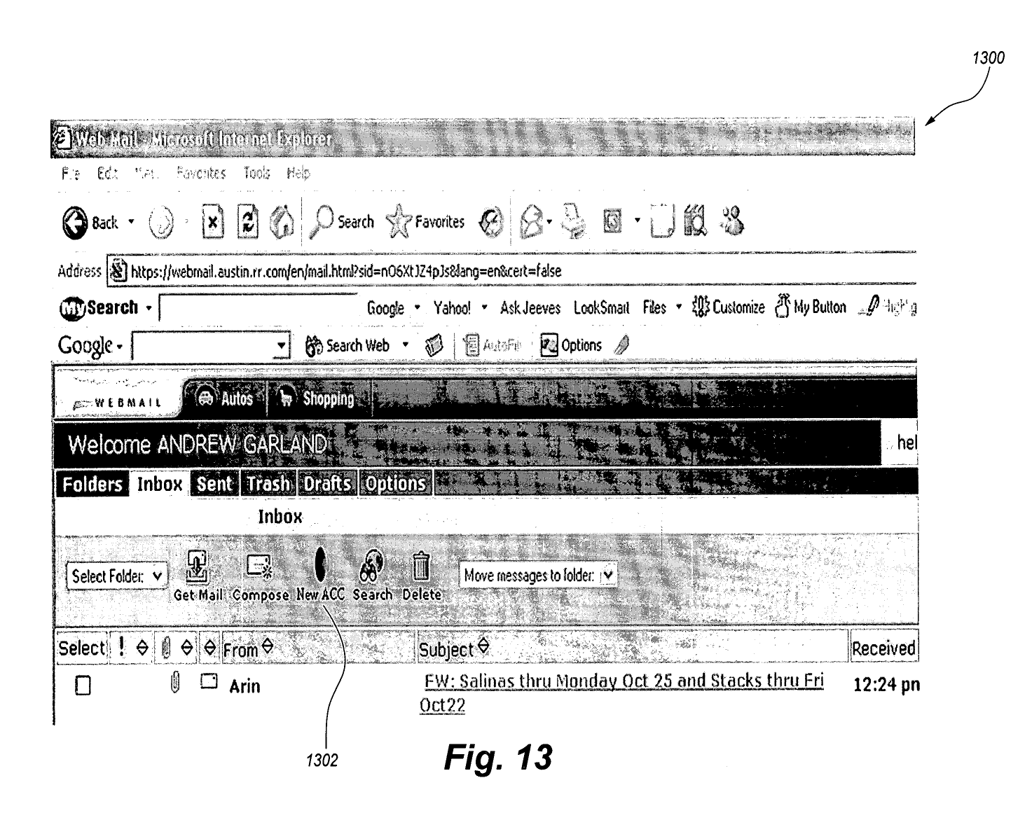

In greater detail, the first step is the message initiation step 20, characterized by a signal from the user to the program notifying the program of the user's intent to create a message. On message initiation 20, an e-mail letter is created. The signal may preferably be given by the clicking or pressing of a message initiation button. Such button may be, but is not necessarily, a hardware button programmed to operate in sync with the program embodying the method of the present invention, an on-screen button displayed in a convenient location, or an icon button integrated an e-mail reader, or displayed by or integrated within a Web browser. Referring to FIG. 6, a screen image 600 is seen having a message initiation button 612 located in a display toolbar 602 in a desktop e-mail application. Referring to FIG. 9, a screen image 900 is seen having a message initiation button 912 displayed within a popup window 916, displayed by a web client application. Similarly, referring to FIG. 13, a screen image 1300 is shown of a web mail application having an integrated message initiation button or icon 1302. During the message initiation step 20, the program will initiate either a new media message or a reply to a received media message. Preferably, if the e-mail reader program is not running, a single click of the message initiation button will activate the program and begin the outgoing e-mail process inherent in that program.

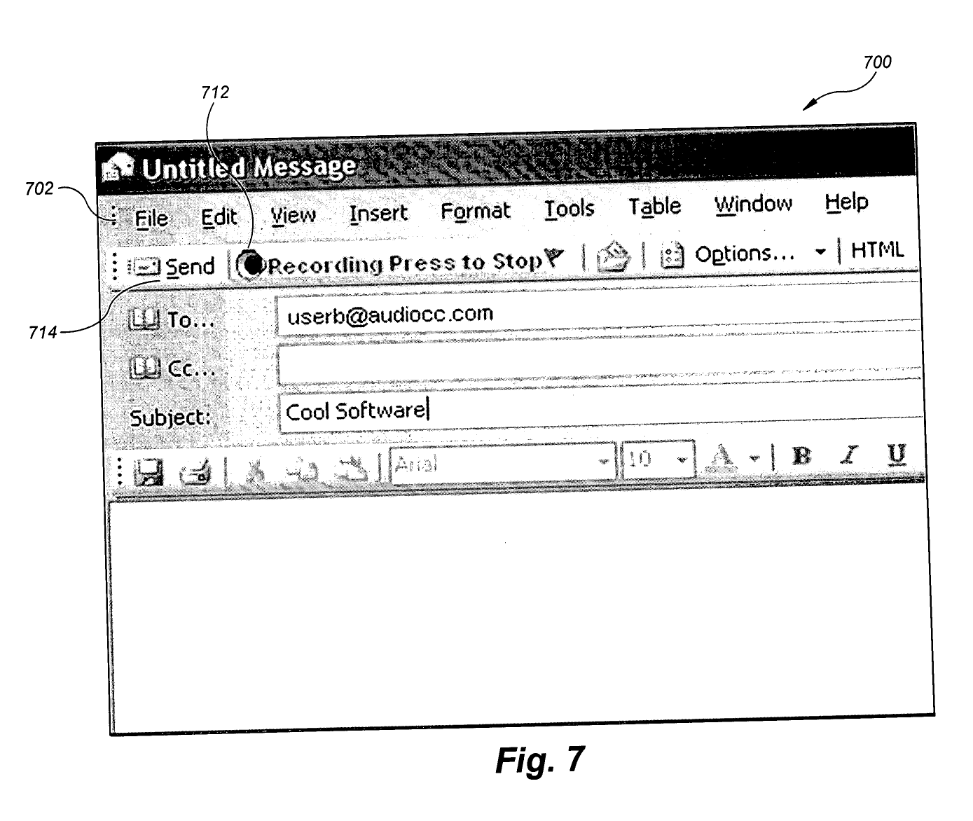

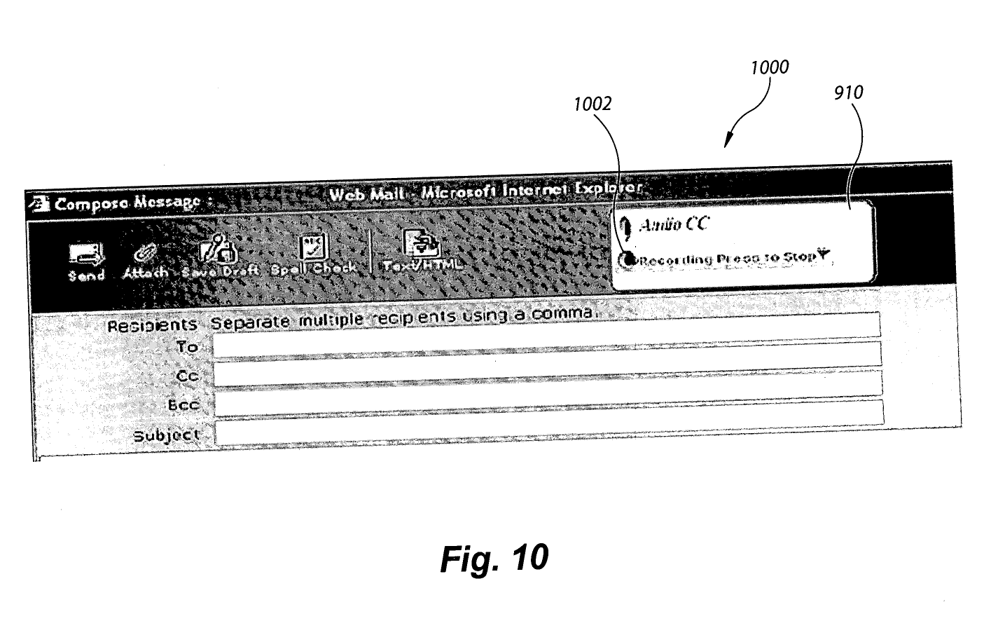

After the message initiation 20, the next step is to record 30 the user message. The precise details of the recording method are not critical and conventional digital recording means and standards may be used and adhered to. The recording step 30 may end in any of a number of ways, such as, but not limited to, extended silence, pressing the message initiation button 20 a second time, or pressing a “stop recording” button. Referring to FIG. 7, a screen image 700 is seen having a “stop recording” button 712 located in a display toolbar 702 in a message composition window displayed by a desktop e-mail application. Additionally, the toolbar 702 conventionally includes a “send” button 714. Referring to FIG. 10, a screen image 1000 is seen having a “stop recording” button 1002 displayed within the popup window 910, displayed by a web client application. The result of the recording step 30 is a media file containing a digital audio, visual or both audio and visual recording of the user message.

Upon the completion of the recording step 30, the next step is to mark the media file with special encoding 40. The principal required effect is the identification and association of the media file with a particular set of correspondences between a particular sender and receiver or group of receivers, the set of correspondences being collectively referred to as a message history or a conversation. A message history or conversation begins with a new message, and includes each subsequent reply or otherwise related message. The precise details of the identification information therefore may vary according to the implementer's style and preference. Such information as a sender's ID, intended receiver's ID, date, time, and an assignment number may be encoded within the file to associate a message with a message history or conversation, but alternative custom coding schemes may be employed with greater or less complexity as desired.

Likewise, the exact manner of encoding is not critical. The encoding may be accomplished in any conventional manner, such as, but not limited to, employing a special file-naming scheme or by including additional information within the actual media file on a lower level.

Once the media file has been encoded, the next step is to store 50 a copy of the encoded file on the sender's computer, or on a web-mail server. The encoded media file should be stored in an orderly fashion in such a way as to facilitate easy and logical access by the program in the future. The storing step 50 should also be designed with the ability to organize an indeterminate number of future files accordingly. As an example, files may be classified in groups and stored accordingly. As there are many adequate conventional storage methods available and well known in the art, this step will not be described in greater detail here.

Once the encoded media file has been stored 50, a copy of the encoded media file is attached 60 to the e-mail letter. The attachment step 60 may utilize the existing attachment means available in an e-mail reader or browser and will not be described further here.

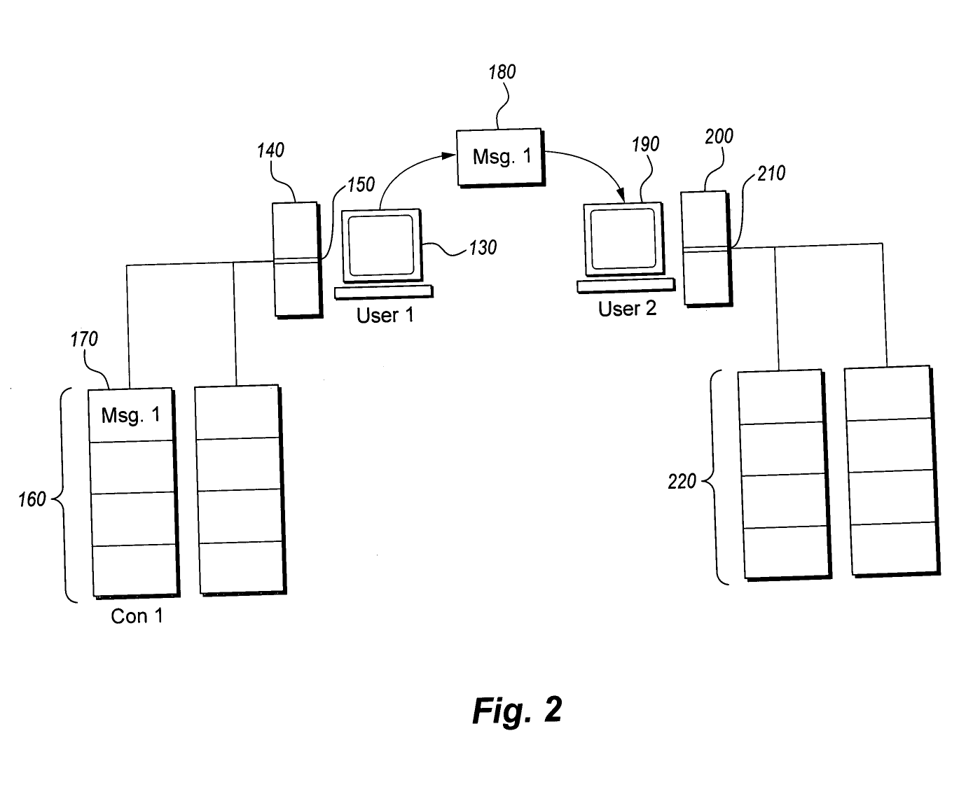

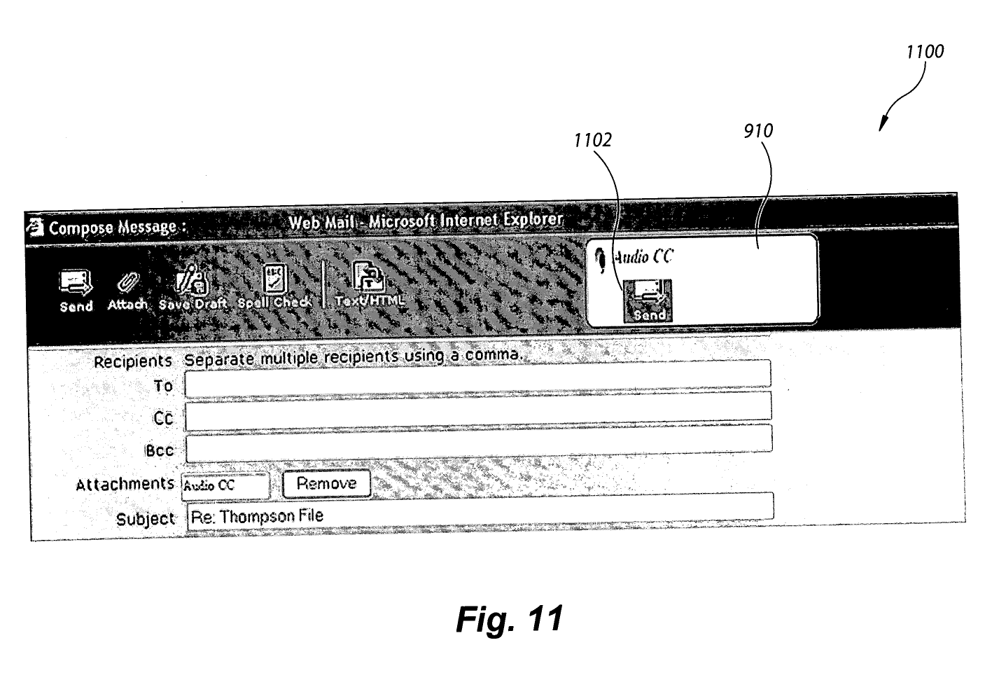

The attached encoded media file is then sent 70 with the e-mail letter to the intended receiver or receivers. The e-mail letter may be sent using the send button 714 (seen in FIG. 7). Alternatively, referring to the screen image 1100 seen in FIG. 11, a send button 1102 or icon may be provided in the popup window 910. The e-mail letter may contain a typical textual message, in addition to the media file, if the sender desires. A snapshot illustrative of the diagram 10 position at line 80 is presented in FIG. 2. The sender, User 1 130, has sent an attached encoded media file 180, labeled “Msg.1” 180, to User 2 190. Although FIG. 2 shows User 1 130 and User 2 190 operating using desktop computers, it should be kept in mind that a desktop computer is merely a single potential client for the program and not limiting. FIG. 2 also shows that a Msg.1 copy 170 has been stored in User 1's hard drive 140 in a cache 150 employing a stack storage scheme 160, labeled “Con.1.” This drawing presents a possible storage format for illustrative purposes and should not be construed as limiting.

In FIG. 1, subsequent to line 80, which will be referred to as the “user switch line,” the diagram steps represent actions taking place on the side of an individual receiver, exemplified by User 2 190 in FIGS. 2-5. The first step for User 2 190 is the receive step 90, in which User 2 190 downloads and accepts the e-mail letter and attachment (s). The receive step 90 may be, but need not be, customized as needed. For example, the program may be specifically designed to incorporate later steps such as processing 100 and displaying links 110 in a more streamlined approach. Alternatively, the program may rely on the established method of downloading incoming mail employed by the underlying e-mail reader program.

Upon receipt of any incoming e-mail letter with an attachment or multiple attachments, the attachment(s) should undergo a processing step 100 to check for specially encoded identification information in order to determine whether the attachment is designated for use with the program. The program may disregard attachments with no recognized encoding. If, during the processing step 100, an attachment is recognized as marked by the special encoding and designated for use, the program must determine the status of the message as a reply or a new message. This may be accomplished in various ways, including, but not limited to, hardcoding the status information directly during the encoding step 40 on User 1's 130 side or, preferably, by comparing the encoded identification information with available information documenting the conversations currently stored in User 2's cache 210.

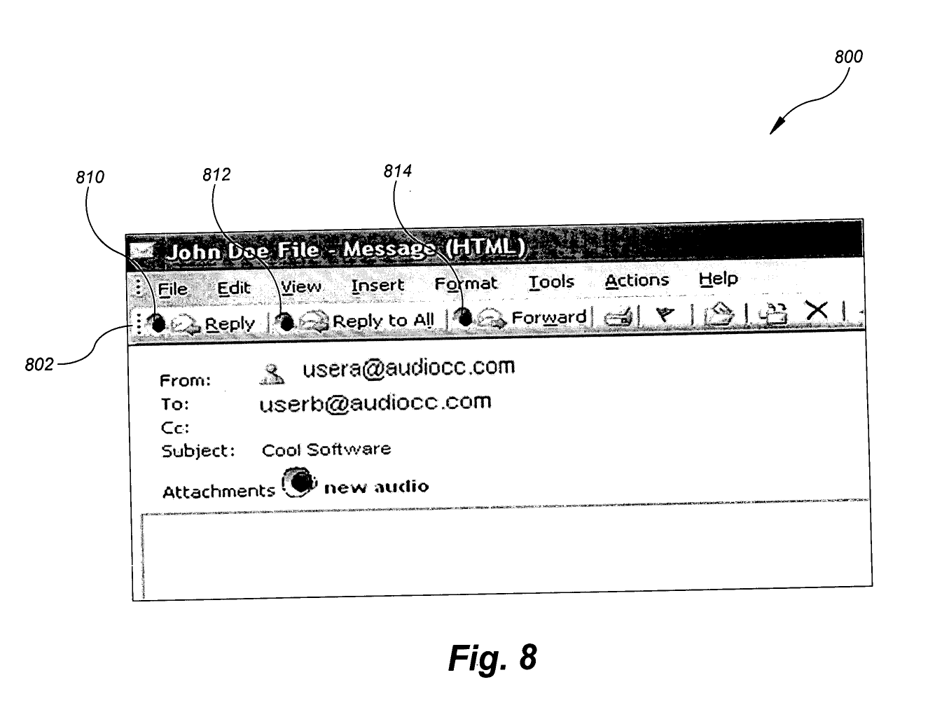

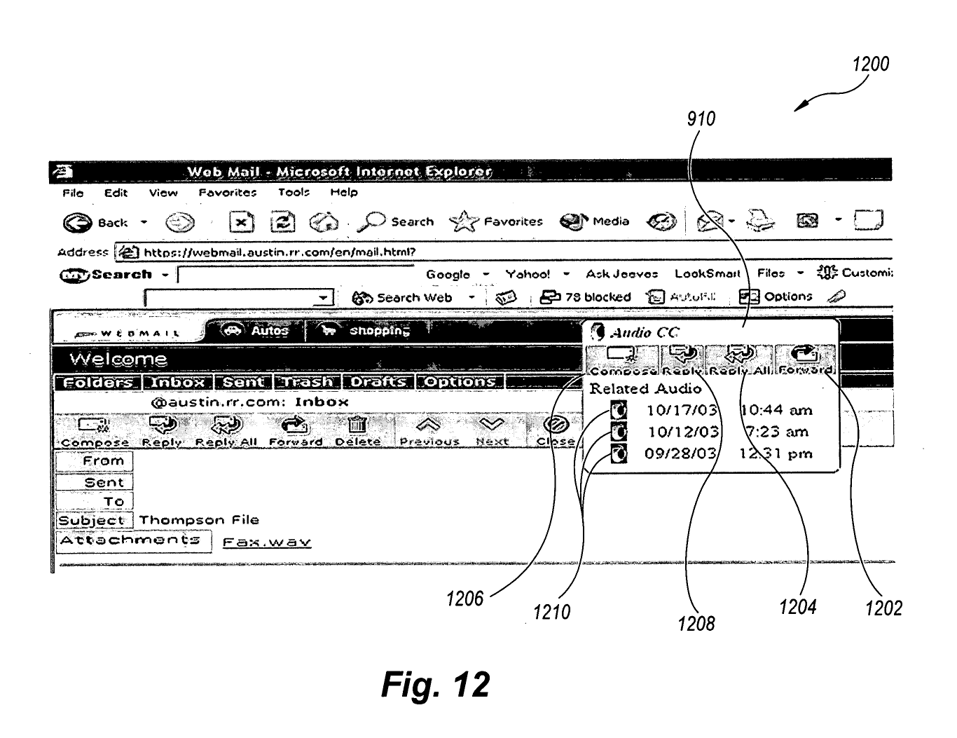

If the attachment represents a new message the program proceeds to a storage step 120 on User 2's computer 200. The storage step 120 operates under the same constraints as the storage step 50 and will not be described further here. After the attachment has been stored, a full cycle around the diagram 10 will have been completed. Starting again at the message initiation step 20, User 2 190 will now have the option to either accept the message with no response or send a reply message and continue the conversation. Referring to FIG. 8, a screen image 800 is seen showing an e-mail message display window, of a desktop e-mail reader, having a “reply” button 810, a “reply to all” button 812, and a “forward” button 814 each located in a display toolbar 802. Each of the buttons 810, 812, 814 function at this point to initiate a new message related to a received message. Similarly, referring to FIG. 12, screen image 1200 is seen including popup window 910, displayed by a web client application, that includes reply 1208, reply to all 1204, and forward 1202 buttons to initiate a new audio message related to a received message, along with a compose button 1206 to initiate a new and unrelated audio e-mail.

Assuming User 2 190 decides to send a reply, User 2 190 will undergo steps 20-70 as a sender in the same manner as did User 1 130. Briefly recapping those steps, User 2 190 will create and record a media file, containing a digitally recorded user message, in the recording step 30. The media file will be marked with identification information relevant to the current conversation during the encoding step 40. Next, a first copy of the encoded media file will be stored according to an orderly storage scheme in the storage step 50. A second copy will be attached to an e-mail letter with the attachment step 60. The e-mail letter with the attached media file will be sent 70.

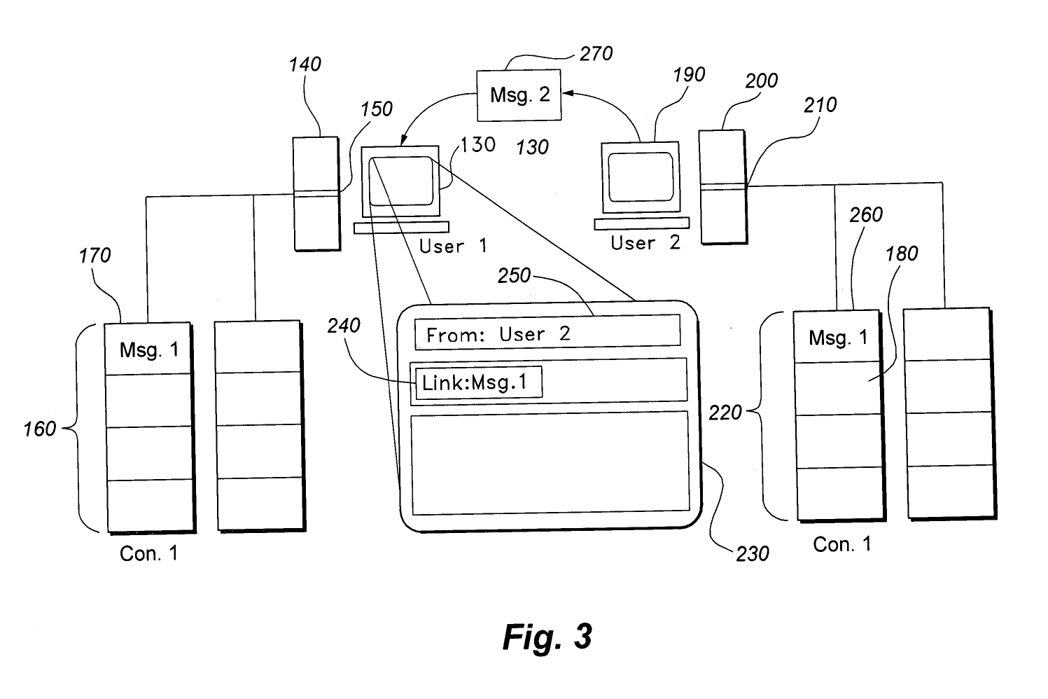

Crossing the user switch line 80, User 1 130 will now be the receiver of a message at step 90. FIG. 3 illustrates a snapshot of User 2 190 sending a reply 270 (“Msg. 2”) and User 1 130 receiving it. The position of the FIG. 3 snapshot within the flowchart diagram 10 is located in between steps 110 and 120.

During the processing step 100 on User 1's 130 side, the encoding of the newly received attachment 270 will be checked. In this case, in contrast to the processing step 100 undergone by User 2 190 of Msg. 1 180, additional information will be found during the search of the storage. Namely, Msg. 1 170 exists with information encoded therein associating Msg. 1 170 with Msg. 2 270 together as part of one and the same conversation. Accordingly, a link 240 to the relevant prior media file will be displayed.

The appearance of the link 240 preferably reflects its order and association with the conversation, however the precise appearance is not critical. The link 240 may be customized to take various forms, such as, but not limited to, a decorative icon with lower text indicating conversation order, or simply a numerical icon.

The precise size and placement of the link 240 is not critical and may depend on the implementation means and platform of the program. For example, should the program be designed to operate on a desktop computer within a common commercial e-mail reader, such as Outlook or Eudora, the link 240 may be placed within an additional bar placed in the top or bottom of an open message window, or in an additional window separate from the program. Referring again to FIG. 12, the popup window 1206 includes a list of icons 1210 providing the links 240 to prior related messages.

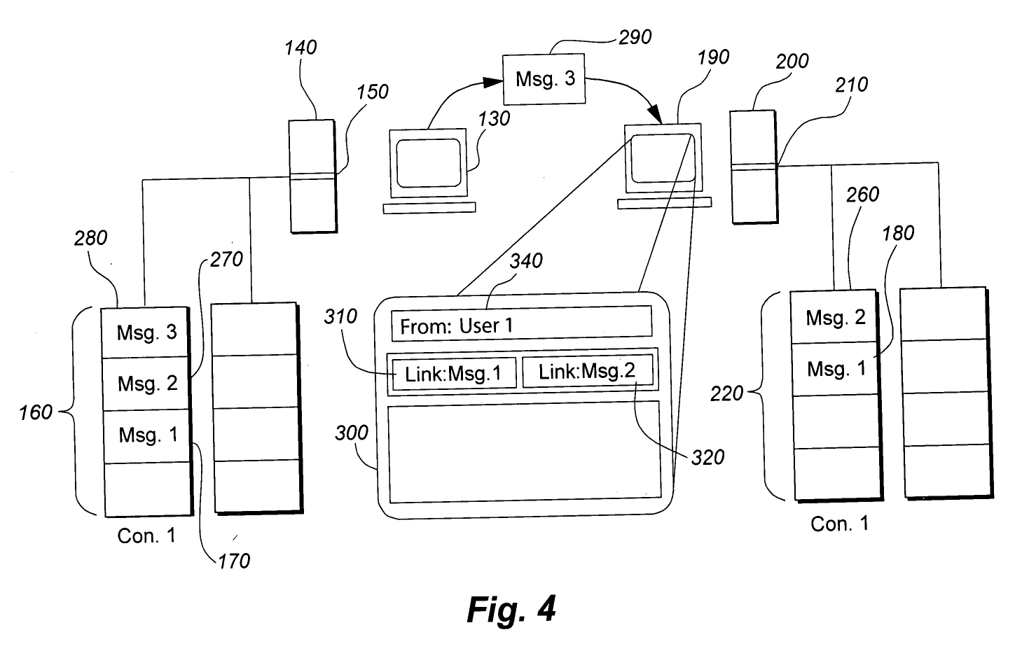

Referring back to FIG. 1, after displaying the link(s), the next step is once again to store 120 the media file. To ensure clarification, FIG. 4 is provided illustrating yet another series of steps around the diagram 10 in which User 1 130 sends a reply 290 back to User 2 190. As FIG. 4 shows, User 2's display 300 will now provide links 310 and 320 pointing to both prior media files 180 and 260 that are associated with the conversation.

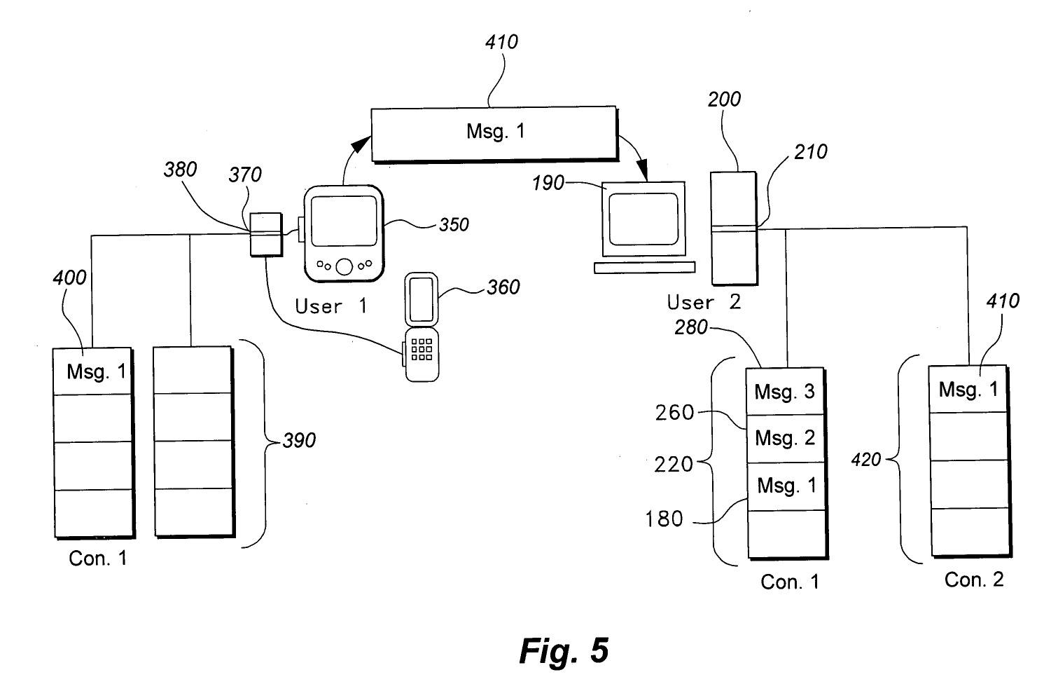

FIG. 5 shows the result of a new conversation initiated by a third party using either a cell phone 360 or a PDA 350. Using the group stack storage method, a new conversation group 420 is formed with first entry being the newly received media file, Msg. 1 410.

By employing the steps of the present invention as outlined above within a computer program, an archival conversation history is maintained among users of the program. Thus, the delayed conversation effect of e-mail is preserved while utilizing more advanced forms of communication than e-mail alone can afford. In addition, it should be noted that during any given e-mail transmission, the burden upon the e-mail system is limited to a single additional media file. Such a burden may be much more easily sustained than the alternative of forwarding growing lists of media file attachments. Using the currently available forwarding technique, the package of e-mail letters and attachments will quickly grow in size until the downloading time becomes so great as to make continued conversation impractical.

It is to be understood that the present invention is not limited to the embodiments described above, but encompasses any and all embodiments within the scope of the following claims.

1. A computerized method of communications via e-mail with media file attachment, comprising the steps of:
initiating on a computer system an outgoing e-mail letter upon signal by a user;
digitally recording a user message;
creating a media file containing said user message;
including in said media file identifying information for identifying the media file and for associating the media file with a conversation;
storing said media file;
attaching a copy of said media file to said e-mail letter; and
sending the e-mail letter with said media file attached to a recipient.

2. The computerized method of claim 1, further comprising the step of issuing a user prompt to begin recording said user message.

3. The computerized method of claim 1, wherein said user message is an audio/visual message

4. The computerized method of claim 1, wherein said user message is an audio message

5. The computerized method of claim 1, wherein said user message is a visual message

6. The computerized method of claim 1, further comprising the steps of:
receiving on said computer system an e-mail reply to said e-mail letter, the reply including a media file containing a user message and identifying information for identifying the media file and for associating the media file with a conversation;
extracting said identifying information;
identifying previous e-mail messages and stored media files associated with said conversation; and
displaying links to said e-mail messages and stored media files associated with said conversation.

7. A computerized method of communications via e-mail with media file attachment, comprising the steps of:
receiving in a computer system a received e-mail message that includes a media file containing identifying information for identifying the media file and for associating the media file with a conversation;
on receiving a user signal, initiating an e-mail reply to said received e-mail letter;
digitally recording a user message;
creating a media file containing said user message;
including in said media file identifying information for identifying the media file and for associating the media file with said conversation;
storing said media file;
attaching a copy of said media file to said e-mail letter; and
sending the e-mail letter with said media file attached to a recipient.

8. The computerized method of claim 7, further comprising the step of issuing a user prompt to begin recording said user message.

9. The computerized method of claim 7, wherein said user message is an audio/visual message.

10. The computerized method of claim 7, wherein said user message is an audio message.

11. The computerized method of claim 7, wherein said user message is a visual message

12. The computerized method of claim 7, further comprising the steps of:
receiving on said computer system a next reply to said e-mail reply, the next reply including a media file containing a user message and information for associating the media file with a said conversation;
identifying previous e-mail messages and stored media files associated with said conversation; and
displaying links to said e-mail messages and stored media files associated with said conversation.
